(19) United States
(12) Patent Application Publication
(10) Pub. No.: US 2005/0139043 A1
(43) Pub. Date: Jun. 30, 2005

(54) Tool for detaching a piston from the disk brake base of a motor vehicle

(76) Inventor: Hsin Fa Kang, Tainan City (TW)

Correspondence Address: Kang Hsin Fa, P.O. Box 90, Tainan City, 704, TW

(21) Appl. No.: 10/745,507

(22) Filed: Dec. 29, 2003

(51) Int. Cl. B25B 7/12

(52) U.S. Cl. 81/302

(57) ABSTRACT

A tool for detaching a piston from the disk brake base of a motor vehicle has an adjusting base assembled near the intermediate portion of a clamping member and fitted thereon with an adjusting button having a threaded rod. When the adjusting button has its threaded rod pushing one clamping member downward, one grasping portion is moved close to the other one and the two clamping portions are reversely expanded outward. Then, two holding blocks of the two clamping members are inserted in a piston and the two grasping portions are held, pressed and the adjusting button is turned tight to make the two clamping portions expanded and positioned to let the outer walls of the two holding blocks firmly press the inner wall of the piston. Then the piston is removed from the chamber of the disk brake base.

### BACKGROUND OF THE INVENTION

1. Field of the Invention

This invention relates to a tool for detaching a piston from the disk brake base of a motor vehicle, particularly to one provided with an adjusting button turned to have its lower threaded rod pushing against the edge of one clamping member to move one grasping portion close to the other grasping portion and make two clamping portions expanded outward reversely. Subsequently, the two holding blocks of the two clamping members are inserted in the piston of a disk brake base and the two grasping portions are held and pressed inward. Then, turn around the adjusting button to expand outward the two clamping portions of the clamping members, and make the outer walls of the two holding blocks firmly press the inner wall of the piston and remove the piston out of the chamber of the disk brake base, convenient to replace a piston or a washer with a new one.

2. Description of the Prior Art

The disk brake base 1 of a motor vehicle, as shown in FIG. 1, includes a base body 10 provided with at least a chamber 11 having its inner wall formed with annular grooves 12 for fitting washers 13 therein and having a piston 14 fitted in the interior. In case the piston 14 or the washer 13 has been used for a long time and causes wear, needed to be replaced with a new one, it is detached from the base body 10 by a piston-detaching tool 2. A conventional piston-detaching tool 2, as shown in FIG. 2, includes two symmetrical clamping members 20, 21 pivotally combined together by a pivot 22. The two clamping members 20, 21 have their front ends respectively formed with a clamping portion 200, 210, and their rear ends respectively provided with a grasping portion 201, 211, having a torsion spring 23 provided between the two grasping portions 201, 211. The torsion spring 23 has two ends respectively hooked on the two grasping portions 201, 211 to expand them outward oppositely and make the two clamping portions 200, 210 closed together. Two holding blocks 202, 212 having pressed grains 203, 213 formed thereon are respectively secured to the front ends of the two clamping portions 200, 210 by bolts. In using, just hold the two grasping portions 201, 211 and insert the two holding blocks 202, 212 of the two clamping members 20, 21 into the piston 14 of the disk brake base 1 and then press inward the two grasping portions 201, 211 to expand outward the two clamping members 20, 21 to force the outer walls with the pressed grains 203, 213 of the two holding blocks 202, 212 firmly pressed on the inner wall of the piston 14, and the piston 14 can be detached from the chamber 11 of the base body 10.

However, the two grasping portions 201, 211 of the conventional piston-detaching tool 2 are always expanded outward oppositely by the torsion spring 23 so the distance between the two grasping portions 201, 211 is unable to be adjusted. Consequently, it is no easy work to tightly hold and press the two grasping portions 201, 211 with one hand to make the two holding blocks 202, 212 firmly pressed on the inner wall of the piston 14 and detach it from the base body 10.

### SUMMARY OF THE INVENTION

The objective of the invention is to offer a tool for detaching a piston from the disk brake base of a motor vehicle, which is able to adjust the distance between two grasping portions to facilitate grasping of the two grasping portions to let two clamping portions firmly pressed on the inner wall of the piston to remove it out of the disk brake base of a motor vehicle.

The feature of the invention is an adjusting base assembled near the intermediate portion of two clamping portions and having an adjusting button fitted thereon.

### BRIEF DESCRIPTION OF DRAWINGS

This invention will be better understood by referring to the accompanying drawings, wherein:

FIG. 1 is a perspective view of a conventional disk brake base of a motor vehicle;

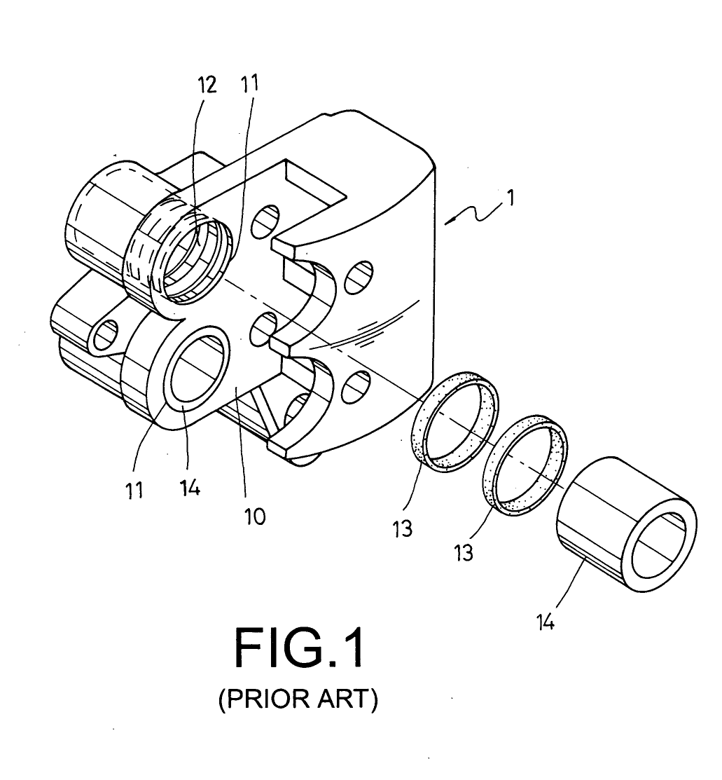

FIG. 2 is a perspective view a conventional piston-detaching tool;

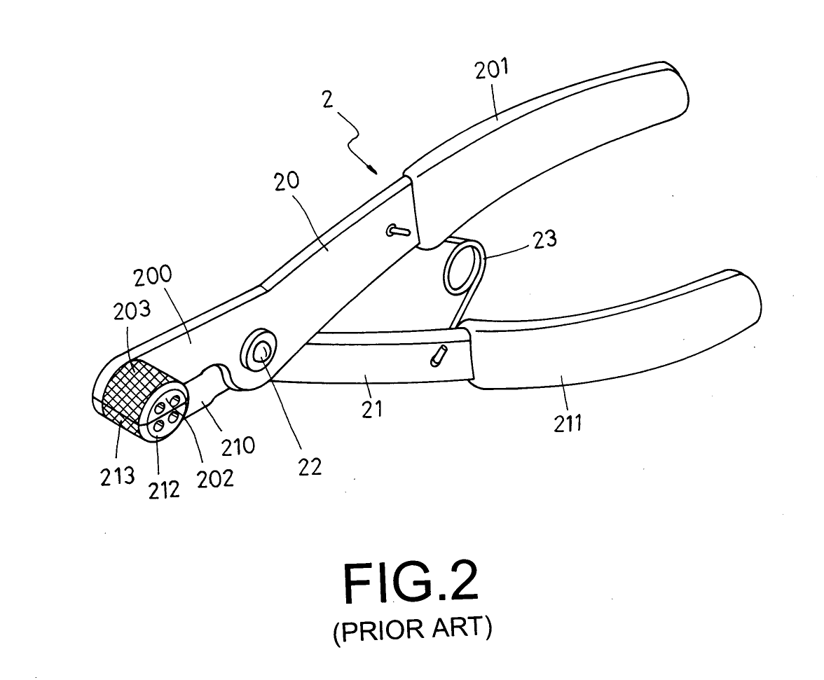

FIG. 3 is an exploded perspective view of a tool for detaching a piston from the disk brake base of a motor vehicle in the present invention;

FIG. 4 is a perspective view of the tool for detaching a piston from the disk brake base of a motor vehicle in the present invention; and,

FIG. 5 is a perspective view of the tool for detaching a piston from the disk brake base of a motor vehicle in a used condition in the present invention.

### DETAILED DESCRIPTION OF THE PREFERRED EMBODIMENT

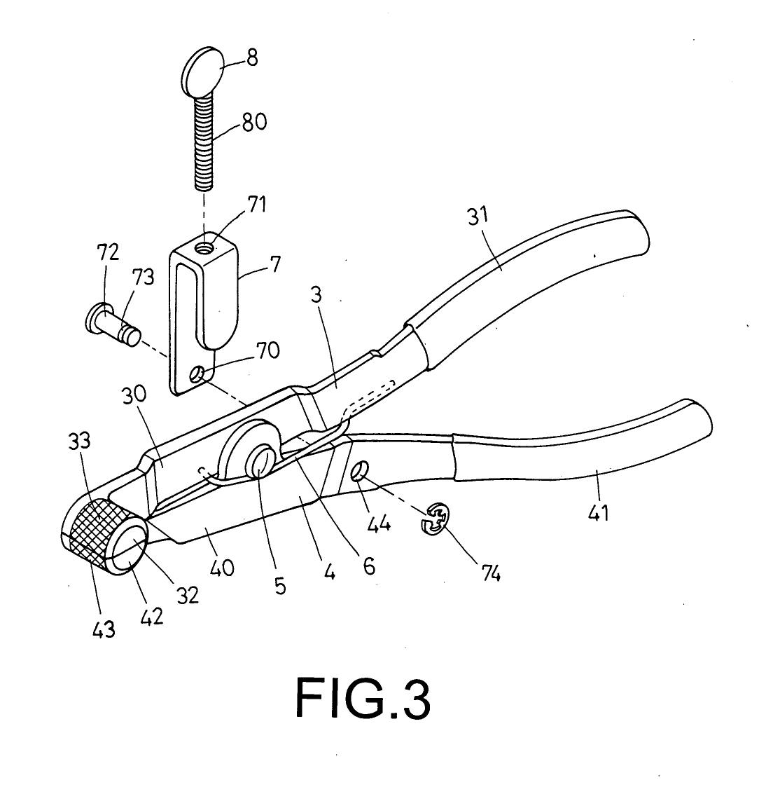

A preferred embodiment of a tool for detaching a piston from the disk brake base of a motor vehicle in the present invention, as shown in FIG. 3, includes two opposite clamping members 3, 4, a torsion spring 6, an adjusting base 7 and an adjusting button 8 as main components combined together.

The two clamping members 3, 4 pivotally combined together by a pivot 5 have their front ends respectively formed with a clamping portion 30, 40 and their rear ends respectively provided with a grasping portion 31, 41.

The torsion spring 6 is fitted around a part of the pivot 5, having one end hooked on the grasping portion 31 of the clamping member 3 and the other end hooked on the clamping portion 40 of the clamping member 4 to make the two grasping portions 31, 41 expanded outward oppositely and the two clamping portions 30, 40 closed together. The two clamping portions 30, 40 respectively have the front end provided with a holding block 32, 42 having pressed grains 33, 43 on the surface, and the clamping member 4 is bored with an insert hole 44.

The adjusting base 7 shaped an inverted U is pivotally assembled on the clamping member 4, having one sidewall bored with an insert hole 70 and its bent portion bored with a threaded hole 71. A pivot 72 formed with an annular groove 73 is inserted through the insert hole 70 of the adjusting base 7 and the insert hole 44 of the clamping member 4 and fixed in place by a snap ring 74 clasped in the annular groove 73.

The adjusting button 8 is threadably assembled on the threaded hole 71 of the adjusting base 7, having its shank formed with a threaded rod 80.

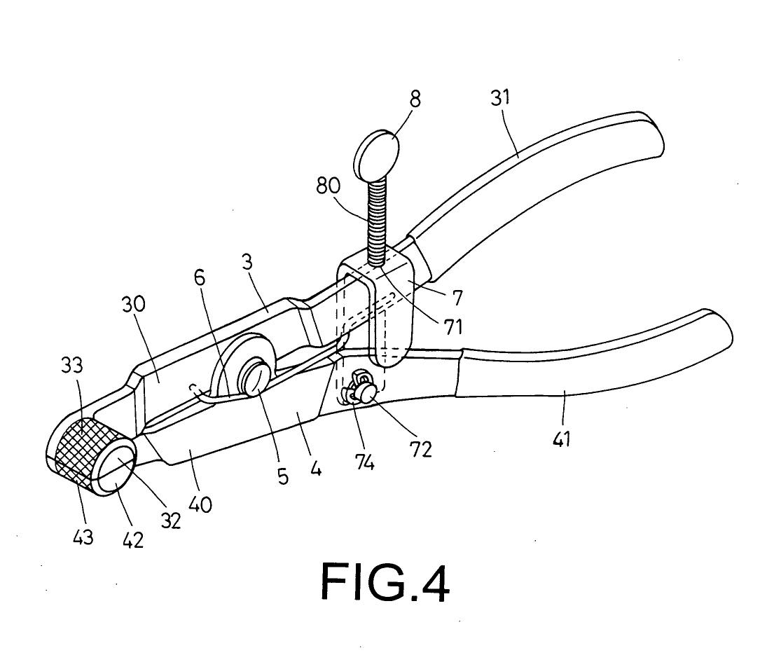

In assembling, as shown in FIGS. 3 and 4, firstly, the adjusting base 7 is mounted astride on the two clamping members 3, 4, letting the insert hole 70 in one side wall of the adjusting base 7 aligned to the insert hole 44 of the clamping portion 4, Next, the pivot 72 is inserted through the insert holes 70, 44 and fixed in position by the snap ring 74 clasped in the annular groove 73 to pivotally fix the adjusting base 7 on the clamping member 4. Lastly, the threaded rod 80 of the adjusting button 8 is screwed in the threaded hole 71 of the adjusting base 7 to finish assembly of the piston-detaching tool.

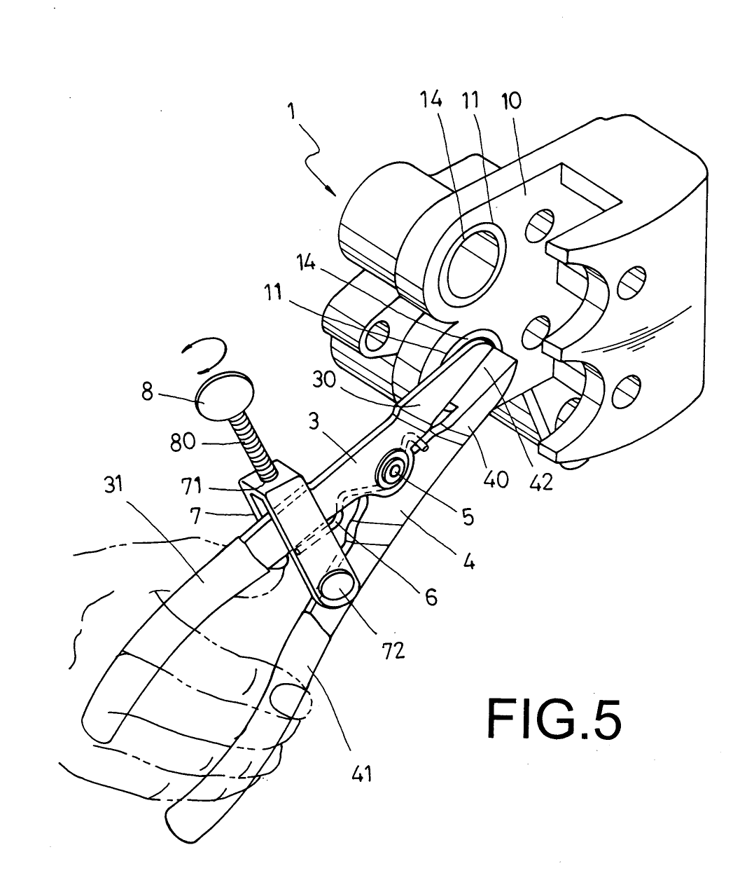

In case the piston 14 or the washer 13 of a disk brake base 1 of a motor vehicle has been used for a long time and causes wear, necessary to be replaced with a new one by means of the piston detaching tool of the invention, as shown in FIG. 5, the adjusting button 8 is turned around to let the lower end of its threaded rod 80 push against the edge of the clamping member 3 and move the grasping portion 31 close to the grasping portion 41. After the adjusting button 8 is turned to press the grasping portion 31 and the two holding blocks 32, 42 of the two clamping portions 30, 40 are expanded outward to a distance approximating to that of the inner diameter of the piston 14, the two holding blocks 32, 42 of the two clamping members 3, 4 are inserted in the piston 14 of a disk brake base 1 and the two grasping portions 31, 41 are held and pressed inward to expand outward the two clamping members 3, 4 once more. Then, the adjusting button 8 is turned tight to make the two clamping portions 30, 40 expanded outward and fixed in position and the outer walls of the two holding blocks 32, 42 pressed firmly on the inner wall of the piston 14. Thus, the piston 14 can easily be detached from the chamber 11 of the base body 10, convenient to replace the piston 14 or the washer 13 with a new one.

While the preferred embodiment of the invention has been described above, it will be recognized and understood that various modifications may be made therein and the appended claims are intended to cover all such modifications that may fall within the spirit and scope of the invention.

1. A tool for detaching a piston from the disk brake base of a motor vehicle comprising two opposite clamping members, said two clamping members pivotally combined together by a pivot, said two clamping members having their front ends respectively formed with a clamping portion, said two clamping members having their rear ends respectively provided with a grasping portion, a torsion spring fitted around a part of said pivot, said torsion spring having one end hooked on said grasping portion of one said clamping member, said torsion spring having the other end hooked on said clamping portion of the other said clamping member, said two grasping portions expanded outward oppositely by said torsion spring, said two clamping portions of said two clamping members closed together when said two grasping portions are expanded outward, said two clamping portions respectively provided with a holding block at the front end, said holding block having its outer wall provided with pressed grains; and,
characterized by an adjusting base assembled near the intermediate portion of said two clamping members, said adjusting base fitted thereon with an adjusting button, said adjusting button having its lower portion formed with a threaded rod, said adjusting button turned around to force said threaded rod push against the edge of one said clamping member, said two grasping portions held and pressed inward oppositely to said two clamping portions expanded outward reversely so as to detach a piston from the chamber of a disk brake base and for replacing said piston or a washer with a new one.

2. The tool for detaching a piston from the disk brake base of a motor vehicle as claimed in claim 1, wherein said adjusting base is shaped an inverted U, having one side wall bored with an insert hole.

3. The tool for detaching a piston from the disk brake base of a motor vehicle as claimed in claim 1, wherein said adjusting base is pivotally assembled on one said clamping member by a pivot having an annular groove for a snap ring to be clasped therein.

4. The tool for detaching a piston from the disk brake base of a motor vehicle as claimed in claim 1, wherein one said clamping member has its intermediate portion bored with an insert hole.
